(19) United States
(12) Patent Application Publication
(10) Pub. No.: US 2007/0152578 A1
(43) Pub. Date: Jul. 5, 2007

(54) Display Panel Structure with a Light Emitting Unit Shielding Structure

(75) Inventors: Min-Ling Hung, Kanding Township (TW); Min-Chieh Hu, Shanhua Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU OPTRONICS CORPORATION, Hsin-Chu (TW)

(21) Appl. No.: 11/539,353

(22) Filed: Oct. 6, 2006

(30) Foreign Application Priority Data
Dec. 30, 2005 (TW) 94147504

(51) Int. Cl. H05B 33/04

(52) U.S. Cl. 313/512

(57) ABSTRACT

A display panel structure is provided, which includes an upper substrate, a lower substrate, a light emitting unit, a desiccating device, and a shielding structure. The light emitting unit is disposed on the lower substrate and between the upper substrate and the lower substrate. The desiccating device is disposed close to the light emitting unit. The shielding structure is disposed on the light emitting unit and between the desiccating device and the light emitting unit. The shielding structure has a width greater than the width of the desiccating device on the upper surface of the light emitting unit. The shielding structure includes a first shielding layer and a second shielding layer. The hardness of the second shielding layer is greater than the hardness of the first shielding layer.

This application claims benefit to a Taiwanese Patent Application No. 094147504 filed on Dec. 30, 2005.

### BACKGROUND OF THE INVENTION

1. Field of the Invention

The present invention relates generally to a light emitting unit shielding structure and a display panel structure using the same.

2. Description of the Prior Art

Display panels have been widely used in all kinds of display apparatus in recent years. The display apparatus which abundantly adopt display panels includes all kinds of monitors, television, personal computer, laptop computer, mobile phone, and digital camera.

Since some light emitting unit, such as organic light emitting device (OLED), is easily damaged by moisture, moisture permeating resistance becomes a serious issue. FIG. 1 shows a sectional view of a prior art OLED panel. As shown in FIG. 1, the OLED panel includes an upper substrate 11, a lower substrate 13, an OLED unit 20, a desiccating layer 30, and a seal 70. The upper substrate 11 is disposed over the lower substrate 13. The OLED unit 20 is disposed on the lower substrate 13 and between the upper and lower substrates 11, 13. The desiccating layer 30 is disposed between the upper substrate 11 and the OLED unit 20. The desiccating layer 30 serves the function of absorbing moisture permeating into the space between the upper and the lower substrate 11, 13 to reduce the damage of the OLED unit 20 caused by the moisture.

The seal 70 is firmly attached to the upper substrate 11 and the lower substrate 13 respectively and surrounds the OLED unit 20 and the desiccating layer 30. The seal 70 also reduces the moisture permeating into the space between the upper substrate 11 and the lower substrate 13.

### SUMMARY OF THE INVENTION

It is an object of the present invention to provide a light emitting unit shielding structure for enhancing the product yield rate.

It is another object of the present invention to provide a light emitting unit shielding structure for extending the life of the emitting unit.

It is a further object of the present invention to provide a light emitting unit eliminating the contact between the desiccating device and the light emitting device.

It is yet another object of the invention to provide a display panel structure having an enhanced yield rate.

It is yet another object of the invention to provide a display panel structure having a longer life of the emitting unit.

The present invention achieves these and other objectives by providing a display panel structure including an upper substrate, a lower substrate, a light emitting unit, a desiccating device, and a shielding structure. The lower substrate is disposed beneath the upper substrate, and a space is formed between the upper substrate and the lower substrate. The light emitting unit is disposed on the lower substrate and between the upper substrate and the lower substrate. In a preferred embodiment, the light emitting unit includes a organic light emitting device (OLED), which has upper and lower electrodes and a light emitting material between the electrodes.

The desiccating device is disposed close to the light emitting unit and located between the upper and lower substrates. In a preferred embodiment, the desiccating device is disposed above the light emitting unit. Due to the arrangement of the desiccating device, the moisture permeating into the space between the upper and lower substrates may be absorbed to reduce damages of OLED caused by the moisture.

The shielding structure is disposed on the light emitting unit and between the desiccating device and the light emitting unit. The shielding structure is disposed to prevent the desiccating device from contacting or having reaction with the light emitting unit, or prevent other elements, such as upper substrate, from contacting or reacting with the light emitting unit. The shielding structure has a width greater than the width of the desiccating device on the upper surface of the light emitting unit. In a preferred embodiment, the shielding structure is formed on the upper surface of the light emitting unit by an evaporation process. The shielding structure includes a first shielding layer and a second shielding layer. The first shielding layer is disposed on the upper surface of the light emitting unit while the second shielding layer is disposed on the first shielding layer. In other words, the second shielding layer is located between the first shielding layer and the desiccating device. The hardness of the second shielding layer is greater than the hardness of the first shielding layer. In addition, a total thickness of the shielding structure is preferably between 0.2 μm and 100 μm.

In a preferred embodiment, the display panel structure of the present invention further includes a seal disposed between the upper substrate and the lower substrate. The seal and the shielding structure are independent to each other; in other words, no contact exists between the seal and the shielding structure. The seal also surround the light emitting unit, the desiccating device, and the shielding structure. The seal firmly connects to the upper and the lower substrates respectively to prevent the moisture from permeating into the space.

### BRIEF DESCRIPTION OF THE DRAWINGS

FIG. 1 is a sectional view of a prior art OLED panel.

FIG. 2 is an explosive view of an exemplary display panel structure of the present invention.

FIG. 3 illustrates a sectional view of the embodiment shown in FIG. 2.

FIG. 4 illustrates a top view of the embodiment shown in FIG. 2.

FIG. 5a shows a sectional view of another exemplary display panel of the present invention.

FIG. 5b shows a top view of the embodiment shown in FIG. 5a.

FIG. 6a shows a sectional view of another embodiment of the display panel.

FIG. 6b shows a sectional view of another embodiment of the display panel.

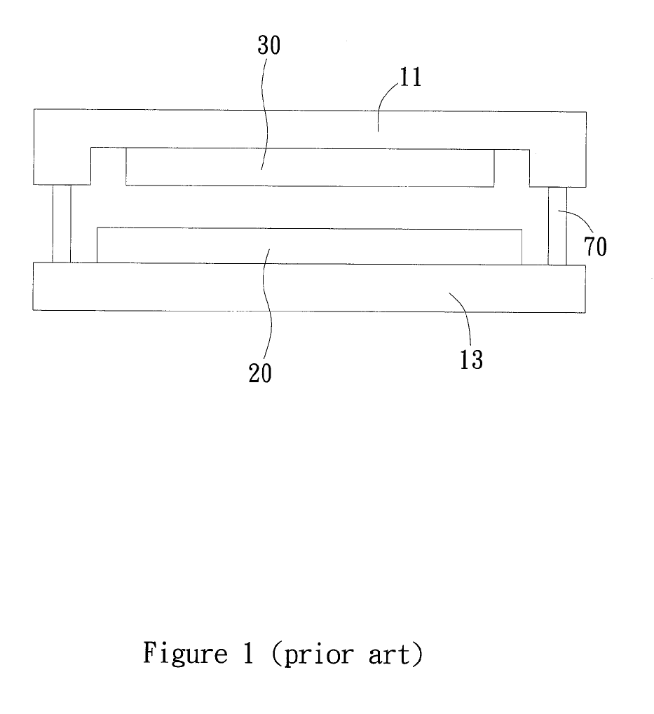

### DETAILED DESCRIPTION OF THE PREFERRED EMBODIMENT

The present invention provides a light emitting unit shielding structure and a display panel using the same. In a preferred embodiment, the display panel of the present invention is a color organic light emitting device (OLED) panel. In another embodiment, however, the display panel of the present invention may also include a self-color OLED panel or other display panel having light emitting unit. The display apparatus using the display panel of the present invention includes panel monitor, panel television, personal computer, laptop computer, mobile phone, and digital camera.

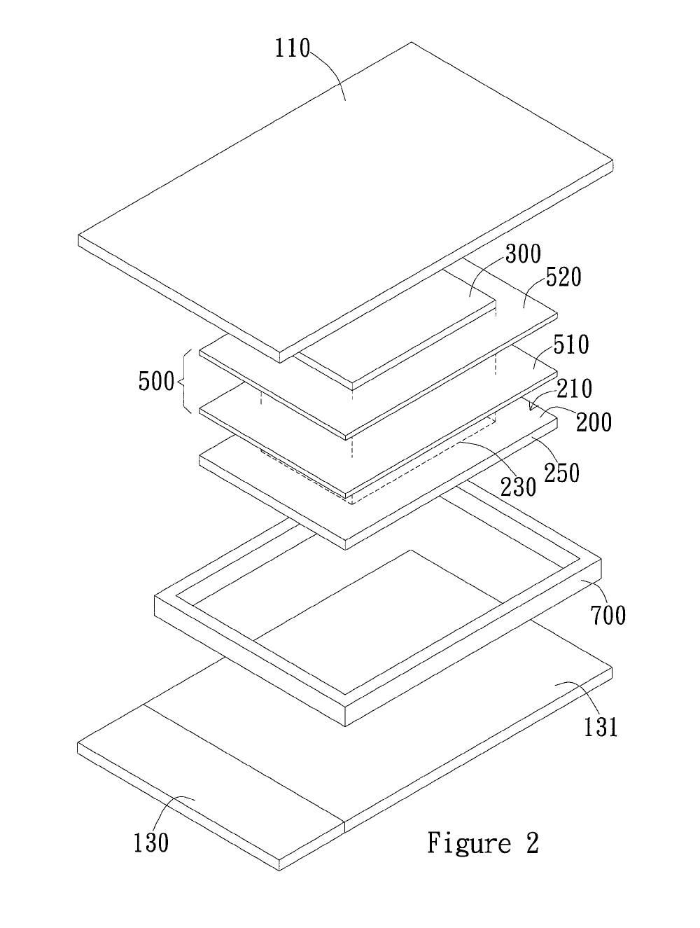

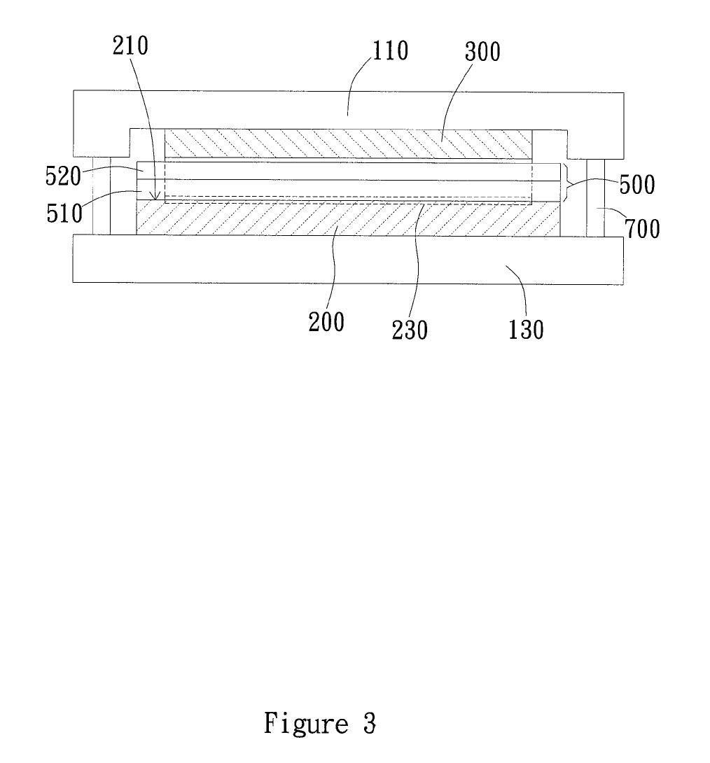

FIG. 2 and FIG. 3 illustrate a preferred embodiment of the display panel structure of the present invention. The display panel structure includes an upper substrate 110, a lower substrate 130, a light emitting unit 200, a desiccating device 300, and a shielding structure 500. The upper substrate 110 may be formed as a cover. The desiccating device 300 may be formed as a layer. As FIG. 2 and FIG. 3 show, the lower substrate 130 is disposed beneath the upper substrate 110, and a space is formed between the upper substrate 110 and the lower substrate 130. The lower substrate 130 includes a transparent display area 131, which is preferably made of glass, organic material, polymer material, or other transparent materials. The upper substrate 110 normally is used as a back plate, or a cover, of the display panel and is preferably made of glass, organic material, polymer material, or other materials.

As shown in FIG. 3, the light emitting unit 200 is disposed on the lower substrate 130 and between the upper substrate 110 and the lower substrate 130. In a preferred embodiment, the light emitting unit 200 includes an organic light emitting device (OLED), which has upper and lower electrodes and a light emitting material between the electrodes. The light emitting unit 200 may be formed on the lower substrate 130 by means of deposition, evaporation, sputtering deposition or other manufacturing process.

In a preferred embodiment, the light emitting unit 200 includes an active light emitting unit, which uses thin film transistors (TFT) or other equivalent elements in cooperation with capacitances to store signals and further control the brightness and gray scale performance of the OLED. In other words, a single pixel may retain its brightness after the scan line passes through the signal is remained in the capacitance. The manufacturing processes for forming the TFT on the lower substrate 130 preferably include amorphous silicon (a-Si) manufacturing process, low temperature poly-silicon (LTPS) manufacturing process, and other manufacturing processes. In another embodiment, however, the light emitting unit 200 may include a passive light emitting unit, i.e., a light emitting unit does not retain any signal. Therefore pixels will be light up only when the scan line is passing through.

The desiccating device 300 is disposed close to the light emitting unit 200 and located between the upper and lower substrates 110 and 130. In the preferred embodiment shown in FIG. 3, the desiccating device 300 is disposed above the light emitting unit 200 and between the upper substrate 110 and the light emitting unit 200. In another embodiment, however, the desiccating device 300 may be disposed on a side of the light emitting unit 200, or surrounding the light emitting unit 200. In addition, as FIG. 3 shows, the surface area of the desiccating device 300 is smaller than the surface area of the light emitting unit 200, or the width of the desiccating device 300 is smaller than the width of the light emitting unit 200. However, in another embodiment, the surface area of the desiccating device 300 may be greater than the surface area of the light emitting unit 200, or the width of the desiccating device 300 may be greater than the width of the light emitting unit 200.

The desiccating device 300 serves the function of absorbing mist and moisture. Due to the arrangement of the desiccating device 300, the moisture permeating into the space between the upper and lower substrates 110, 130 may be absorbed to reduce damages of OLED caused by the moisture.

As illustrated in FIG. 2 and FIG. 3, the shielding structure 500 is disposed on the light emitting unit 200 and between the desiccating device 300 and the light emitting unit 200. The shielding structure 500 is disposed to prevent the desiccating device 300 from contacting or having reaction with the light emitting unit 200, or prevent other elements, such as upper substrate 110, from contacting or reacting with the light emitting unit 200. In a preferred embodiment, a space is existed between the shielding structure 500 and the desiccating device 300. In another embodiment, however, the shielding structure 500 may contact the desiccating device 300. The shielding structure 500 is preferably formed on the upper surface 210 of the light emitting unit 200 through an evaporation process. However, the shielding structure 500 may be formed on the upper surface 210 by using different manufacturing process, such as coating or sputtering deposition process. In addition, the shielding structure 500 may include either a single layer or multiple layers.

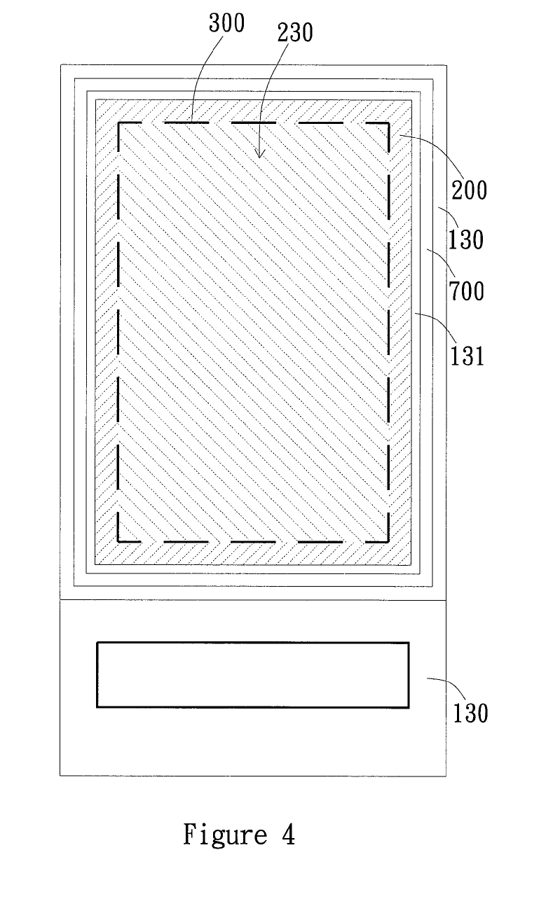

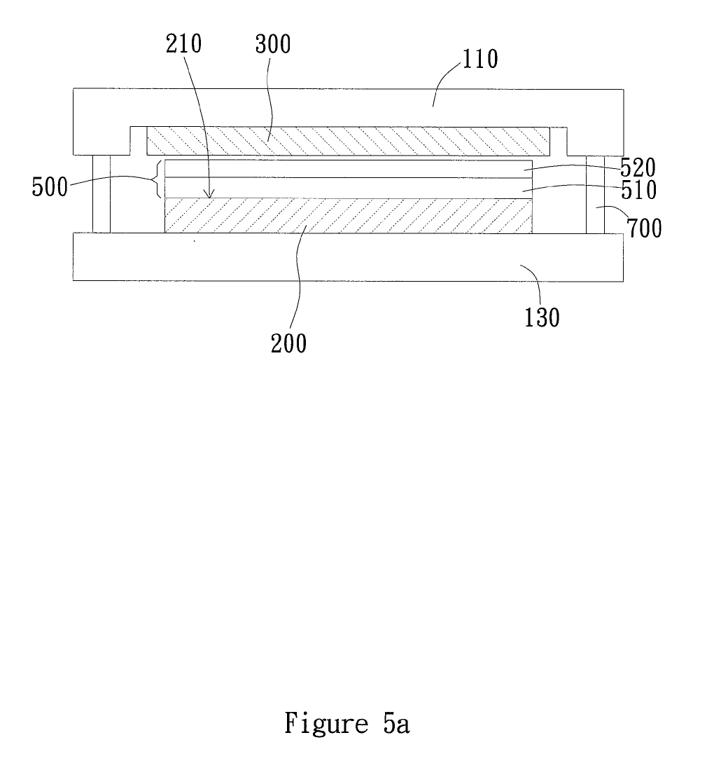

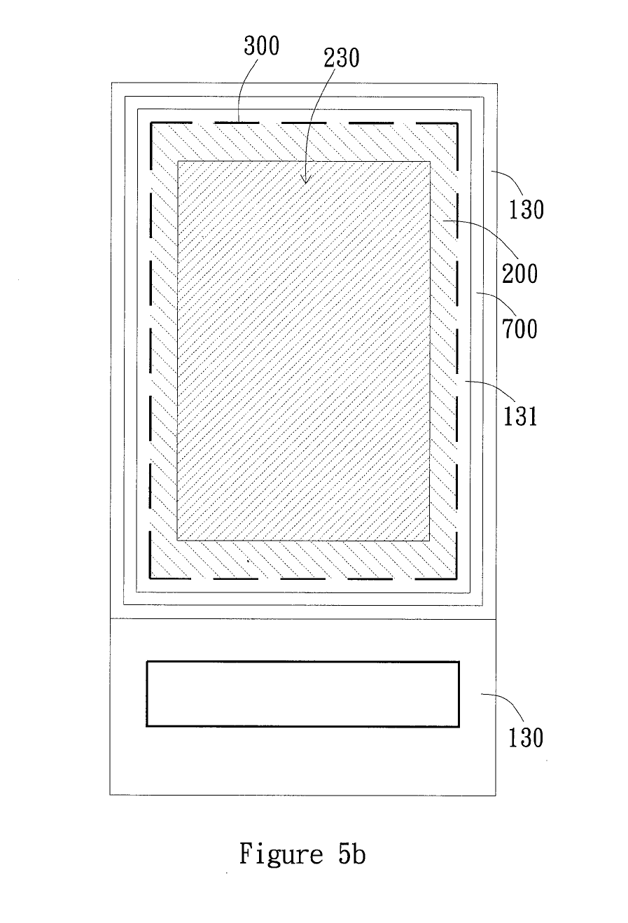

As FIG. 2, FIG. 3, and FIG. 4 show, the shielding structure 500 covers a projection area 230 corresponding to the desiccating layer 300 on the upper surface 210 of the light emitting unit 200, in other words, the width of the shielding structure 500 is equal to or greater than the width of the desiccating layer 300. In the preferred embodiment shown in FIG. 3, the projection area 230 includes an orthographic projection area of the desiccating layer 300 on the upper surface 210. In another embodiment, however, the projection area 230 may include other different kinds of projection of the desiccating device 300 on the upper surface 210. In addition, in the embodiment of FIG. 3 and FIG. 4, a surface area of the desiccating device 300 is smaller than the area of the upper surface 210 of the light emitting unit 200, which means that the projection area 230 only includes a part of the upper surface 210 of the light emitting unit 200. In another embodiment shown in FIG. 5a and FIG. 5b, however, the surface area of the desiccating device 300 is greater than the area of the upper surface 210 of the light emitting unit 200. The width of the shielding structure 500 is less than the width of the desiccating device 300. In this embodiment, the projection area 230 includes a full area of the upper surface 210 of the light emitting unit 200.

As illustrated in FIG. 2 and FIG. 3, the shielding structure 500 includes a first shielding layer 510 and a second shielding layer 520. The first shielding layer 510 is disposed on the upper surface 210 of the light emitting unit 200 while the second shielding layer 520 is disposed on the first shielding layer 510. In other words, the second shielding layer 520 is located between the first shielding layer 510 and the desiccating device 300. In addition, the second shielding layer 520 preferably completely covers the first shielding layer 510. In a preferred embodiment, the first shielding layer 510 is formed on the upper surface 210 of the light emitting unit 200 by an evaporation process. However, the first shielding layer 510 may be formed on the upper surface 210 by using different manufacturing process, such as taping coating or sputtering deposition process. Similarly, the second shielding layer 520 is preferably formed on the first shielding layer 510 by an evaporation process. However, the second shielding layer 520 may be formed on the first shielding layer 510 by using different manufacturing process, such as taping, coating or sputtering deposition process.

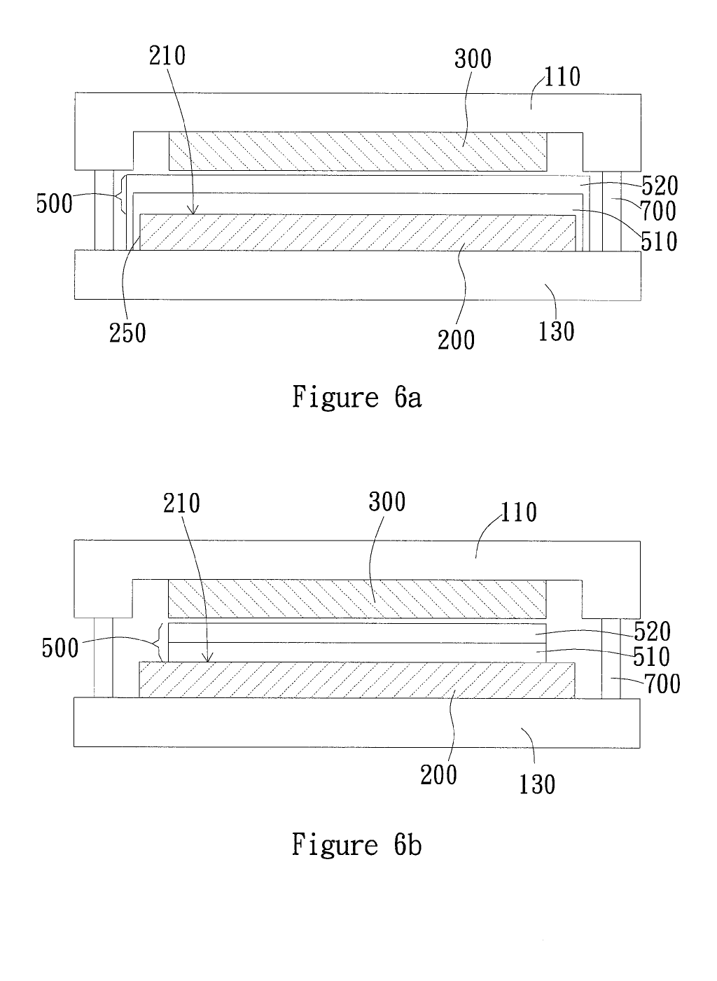

FIG. 6a illustrates another embodiment of the display panel structure. In this embodiment, the shielding structure 500 covers not only the projection area 230 but also a side wall 250 of the light emitting unit 200. As FIG. 6a shows, the first shielding layer 510 covers the side wall 250 while the second shielding layer 520 covers a side surface of the first shielding layer 510. The width of the first shielding layer 510 or the second shielding layer 520 is greater than the width of the light emitting unit 200 or the desiccating device 300. In another embodiment shown in FIG. 6b, however, the shielding structure 500 may only cover the projection area 230 and expose other parts of the light emitting unit 200. The width of the first shielding layer 510 or the second shielding layer 520 is equal to or less than the width of the light emitting unit 200. The width of the first shielding layer 510 or the second shielding layer 520 is equal to the width of the desiccating device 300.

The second shielding layer's 520 hardness is greater than the first shielding layer's 510 hardness. The softer first shielding layer 510 provides a cushion effect to protect the light emitting unit 200. In another embodiment, however, the second shielding layer's 520 hardness may be smaller than the first shielding layer's 510 hardness. The softer second shielding layer 520 provides a cushion effect to prevent the desiccating device 300 or the upper substrate 110 from contacting, compressing, or reacting with the light emitting unit 200. However, the hardness of the first and the second shielding layers 510, 520 may be varied to satisfy different demands and are not limited by the present invention. In this preferred embodiment, the hardness includes a hardness coefficient; however, the hardness may include a rigidity coefficient or other indexes relative to the deformation resistance. In addition, in a preferred embodiment, the hardness of the shielding structure 500 is smaller than the hardness of the desiccating device 300. In other words, both the first shielding layer 510 and the second shielding layer 520 are softer than the desiccating device 300 to provide a shock-absorbing function and protect the light emitting unit 200. Also, the shielding structure 500 may include a single layer structure, which is softer than the desiccating device 300, for providing cushion and shielding functions to protect the light emitting unit 200. In another embodiment, however, the hardness of the shielding structure 500 may be greater than the hardness of the desiccating device 300 to protect the light emitting unit 200 during transportation. In summary, the hardness of the shielding structure 500 and the desiccating device 300 may be varied in view of the actual demand of the product design.

The first shielding layer 510 is preferably made of polymer materials. In another embodiment, however, the first shielding layer 510 may be made of other organic materials or inorganic material softer than the second shielding layer 520. The second shielding layer 520 is preferably made of metal materials, which includes alloy materials and other metal materials. In another embodiment, however, the second shielding layer 520 may be made of inorganic or organic materials which are harder than the first shielding layer 510.

When the shielding structure 500 is a single-layer structure, its thickness is preferably between 0.2 μm and 100 μm. The thickness between 0.5 μm and 100 μm is more preferred. It may be made of organic materials, inorganic materials, metal materials, or alloy materials. However, the thickness of the shielding structure 500 may over the range suggested above to serve any particular product design demand. On the other hand, when the shielding structure 500 includes a multiple-layer structure which includes the first shielding layer 510 and the second shielding layer 520, the thickness of the first shielding layer 510 is preferably between 0.2 μm and 100 μm, and more preferably between 0.5 μm and 100 μm. The thickness of the second shielding layer 520 is preferably between 0.2 μm and 100 μm, and more preferably between 0.5 μm and 100 μm.

As shown in FIG. 2 and FIG. 3, the display panel structure of the present invention further includes a seal 700. The seal 700 is disposed between the upper substrate 110 and the lower substrate 130 and surround the light emitting unit 200, the desiccating device 300 and the shielding structure 500. In this preferred embodiment, the seal 700 firmly attaches to the upper and lower substrates 110, 130 respectively to seal the space between the upper and lower substrates 110, 130 and prevent the moisture from permeating into the space between the upper and lower substrates 110, 130. In addition, the seal 700 preferably includes a photo-sensitive material such as an ultraviolet-sensitive material. The photo-sensitive material includes any material having photo-triggered solidifiability. However, the seal 700 may be made of thermo-set materials or expandable materials.

It should be note that the seal 700 and the shielding structure 500 are independently disposed, i.e., there is no contact or no overlap between the seal 700 and the shielding structure 500. As FIG. 3 shows, a gap exists between the seal 700 and the shielding structure 500. Since the seal 700 does not contact to or overlap the shielding structure 500, the seal 700 is able to firmly connect to the upper substrate 110 and the lower substrate 130.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A display panel, comprising:
an upper substrate;
a lower substrate disposed beneath the upper substrate;
a light emitting unit disposed on the lower substrate and between the upper substrate and the lower substrate;
a desiccating device disposed close to the light emitting unit and between the upper substrate and the lower substrate; and
a shielding structure disposed on the light emitting unit and between the desiccating device and the light emitting unit, wherein the shielding structure has a width greater than the width of the desiccating device, and the shielding structure includes:
a first shielding layer located on the upper surface of the light emitting unit; and
a second shielding layer located on the first shielding layer, wherein the second shielding layer has a hardness greater than that of the first shielding layer.

2. The display panel of claim 1, wherein the desiccating device has a width less than the width of the light emitting unit.

3. The display panel of claim 1, wherein the desiccating device has a width greater than or equal to the width of the light emitting unit.

4. The display panel of claim 1, wherein the first shielding layer covers a side wall of the light emitting unit.

5. The display panel of claim 1, wherein the second shielding layer completely covers the first shielding layer.

6. The display panel of claim 1, wherein the shielding structure has a thickness of between about 0.2 μm and about 100 μm.

7. The display panel of claim 1, wherein the shielding structure has a thickness of between about 0.5 μm and about 1100 μm.

8. The display panel of claim 1, further comprising a seal disposed between the upper substrate and the lower substrate, wherein the seal and the shielding structure are not overlapped.

9. The display panel of claim 1, further comprising a seal disposed between the upper substrate and the lower substrate, wherein the seal and the shielding structure are not contact.

10. The display panel of claim 1, wherein the first shielding layer is made of a material including an organic material or a polymer material.

11. The display panel of claim 1, wherein the second shielding layer is made of a material selected from the group consisting of metal, alloy, an inorganic material, and combinations thereof.

12. The display panel of claim 1, wherein the light emitting unit includes an organic light emitting device.

13. The display panel of claim 1, wherein the desiccating device and the shielding structure contact with each other.

14. The display panel of claim 1, wherein the first shielding layer has a thickness of between about 0.2 μm and about 100 μm.

15. The display panel of claim 1, wherein the first shielding layer has a thickness of between about 0.5 μm and about 100 μm.

16. The display panel of claim 1, wherein the second shielding layer has a thickness of between about 0.2 μm and about 100 μm.

17. The display panel of claim 1, wherein the second shielding layer has a thickness of between about 0.5 μm and about 100 μm.

18. The display panel of claim 1, wherein the desiccating device has a hardness greater than that of the shielding structure.

19. A display panel, comprising:
an upper substrate;
a lower substrate disposed beneath the upper substrate;
a light emitting unit disposed on the lower substrate and between the upper substrate and the lower substrate;
a desiccating device disposed close to the light emitting unit and between the upper substrate and the lower substrate; and
a shielding structure disposed on the light emitting unit.

20. The display panel of claim 19, further comprising a seal disposed between the upper substrate and the lower substrate.

21. The display panel of claim 20, wherein the seal and the shielding structure are not overlapped.

22. The display panel of claim 19, wherein the shielding structure has a thickness of between about 0.2 μm and about 100 μm.

23. The display panel of claim 19, wherein the shielding structure has a thickness of between about 0.5 μm and about 100 μm.

24. The display panel of claim 19, wherein the shielding structure is made of a material selected from the group consisting of metal, alloy, an organic material, a polymer material, an inorganic material and combinations thereof.

25. The display panel of claim 19, wherein the desiccating device is disposed on the upper substrate.

26. The display panel of claim 19, wherein the desiccating device has a hardness greater than the hardness of the shielding structure.

27. The display panel of claim 19, wherein the desiccating device has a hardness less than the hardness of the shielding structure.
